(19) United States
(12) Patent Application Publication
(10) Pub. No.: US 2022/0266917 A1
(43) Pub. Date: Aug. 25, 2022

(54) A Roof Module Having an Environment Sensor

(71) Applicant: Webasto SE, Stockdorf (DE)

(72) Inventors: Michael HUELSEN, Stockdorf (DE); Dirk LEGLER, Stockdorf (DE); Max HUBER, Stockdorf (DE); Thomas LINDNER, Munich (DE)

(21) Appl. No.: 17/632,908

(22) PCT Filed: Aug. 13, 2020
(86) PCT No.: PCT/EP2020/072767

§ 371 Date: Feb. 4, 2022

(30) Foreign Application Priority Data
Aug. 19, 2019 (DE) 10 2019 122 175.7

(51) Int. Cl. B62D 25/06

(52) U.S. Cl. CPC B62D 25/06

(57) ABSTRACT

A roof module of a motor vehicle having a roof substructure, a roof cladding, which forms an outer visible surface of the roof module, and at least one sensor module having an environment sensor for sensing a vehicle environment, the roof cladding having a central section having a curved surface and at least one edge section, which adjoins the central section and whose incline is larger than the incline of the central section and which is transparent to the environment sensor at least in the area of a signal cone of the environment sensor. The environment sensor being at least partially disposed below a roof surface defined by the roof cladding.

The invention relates to a roof module of a motor vehicle which comprises a roof substructure, a roof cladding and a sensor module having an environment sensor for sensing a vehicle environment.

In vehicle technology, self-driving or partially self-driving vehicles are becoming more and more widespread. In order to enable autonomous or partially autonomous driving of motor vehicles which meets high safety standards, a vehicle control system must be connected to a plurality of environment sensors which sense the environment of the vehicle, making it possible to identify and analyze the present traffic situation. It is known that sensor modules having environment sensors for monitoring the vehicle environment are fastened to the vehicle roof as the vehicle roof generally constitutes the highest point of a vehicle, the vehicle environment being clearly visible form this vantage point.

A sensor module, which is placed on a roof cladding, thereby resulting in a visually not too pleasing appearance, is used for hitherto known vehicle roofs having environment sensors. Moreover, the aerodynamics of the resulting vehicle roof are unsatisfactory, which in turn is reflected in the energy consumption of the vehicle in question.

The object of the invention is to create a roof module which comprises a sensor module and meets the high standards regarding aerodynamics and visual appearance.

According to the invention, this object is attained by the roof module having the features of claim 1.

The invention thus uses the basic idea of dividing a roof cladding, which forms an outer visible surface of the roof module, into a central section and an edge section which adjoins the central section and whose incline is larger than the incline of the central section and which is transparent to the environment sensor or rather to the wavelength used by the environment sensor. Consequently, the environment sensor can “see” through the edge section having the large incline, which in turn makes it possible to dispose the environment sensor at least partially below a roof surface defined by the roof cladding.

By using and placing the environment sensor in the area of the edge section which forms a reclining roof line, the edge section can be used as a window which is permeative for the environment sensor or the wavelength used by the environment sensor. Thus, the environment sensor can be integrated into the roof design so as to be aesthetically pleasing, which offers great advantages regarding design, optics, crash safety, functional integration of cleaning elements, heating elements, cooling elements and/or the like.

The environment sensor of the roof module according to the invention can be realized in various manners and can be a Lidar sensor, a radar sensor, an optical sensor such as a camera or the like.

The roof module according to the invention allows using outer corners and outer edges and roof lines reclining in particular in this area for disposing the environment sensor in such a manner that it becomes an integrated permanent component of the roof module, which only requires little construction space. The reclining edge section, which is transparent to the environment sensor, provides the required visible area. In particular elements or areas of the roof cladding, which are present in any case, can be used for covering the environment sensor or rather the sensor module comprising the environment sensor.

The edge section, which can be curved or domed and has the larger incline compared to the also generally curved or domed central section, is made in particular of a raw material permeative to the radiation or the wavelength used by the environment sensor and can be a visor, for example, which is made of glass or plastic. Consequently, the edge section of the roof cladding is a visor which itself forms a window for the environment sensor. The edge section can be made in one piece with the central section.

In general, the rood module according to the invention can be an entirely rigid roof or comprise a roof opening system. It can be configured such that it can be placed on top of a vehicle shell construction by the vehicle manufacturer as a construction unit which comprises integrated devices for a driving autonomous or partially autonomous driving mode. The roof module can be designed for use in a passenger car or a utility vehicle.

In a preferred embodiment of the roof module according to the invention, the edge section having the incline larger than the incline of the central section forms a front windshield cowl or a rear windshield cowl of the vehicle in question.

Additionally or alternatively thereto, the edge section having the incline larger than the incline of the central section with respect to the vertical longitudinal roof center plane can form a lateral edge strip, which adjoins a lateral roof beam of a vehicle chassis when the roof module is mounted.

The central section is limited in such a manner by the central section that the boundary is defined by an inner edge of the sensor module facing the roof center, for example. It is also possible for the boundary to be defined by an inner edge of a separate visor.

The roof module according to the invention is preferably realized in such a manner that the edge section or the roof line formed by the edge section reclines in the area of the environment sensor by a minimum angle. During operation, the environment sensor emits a signal cone which has an opening angle from a horizontal plane downward, the opening angle being smaller than the incline of the lateral section. As a result, the environment sensor has an unimpeded view which is not hindered by other vehicle components or roof components.

In a special embodiment of the roof module according to the invention, the opening angle of the signal cone is 15° to 20° from a horizontal plane downward, the incline of the edge section being larger by at least 4°, in particular at least 6°. Depending on the intended use, the downward opening angle of the signal cone can be larger than 20° or smaller than 15°.

The sensor module having the environment sensor is preferably integrated in such a manner into the roof module that it has a permanent connection to the roof substructure.

The roof substructure can be formed by a roof frame and/or a transverse bow or even be a component of the vehicle shell construction in a special embodiment of the roof module according to the invention, the roof module being able to be mounted on the vehicle shell construction. A visor or a casing of the sensor module does not or only slightly protrudes over a virtual roof line, which would be indicated in a roof module without a sensor module, owing to the placement of the sensor module in the edge section. Thus, the roof module according to the invention does not have any significant superstructures or protrusions which would intrude on the visual appearance. It is also possible to fasten the sensor module on the roof cladding or on an edge section of the roof cladding.

Further advantages and advantageous embodiments of the subject matter of the invention become apparent from the description, the drawing and the claims.

An exemplary embodiment of a roof module according to the invention is illustrated in the drawing in a schematically simplified manner and is described in further detail in the following description.

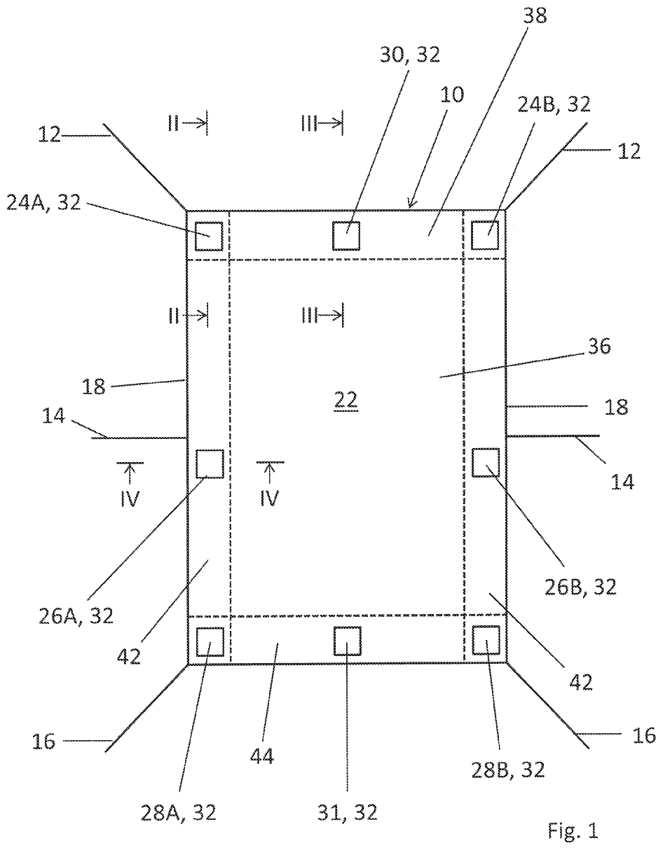

FIG. 1 shows a top view of a motor vehicle having a roof module according to the invention;

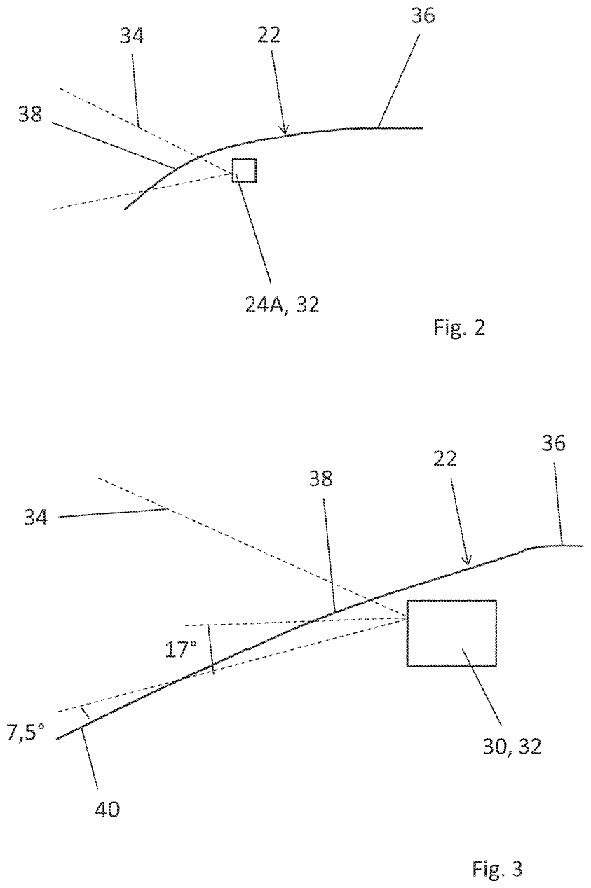

FIG. 2 shows a cross-sectional view of the roof module along cutting plane II-II in FIG. 1;

FIG. 3 shows a cross-sectional view of the roof module along cutting plane III-III in FIG. 1;

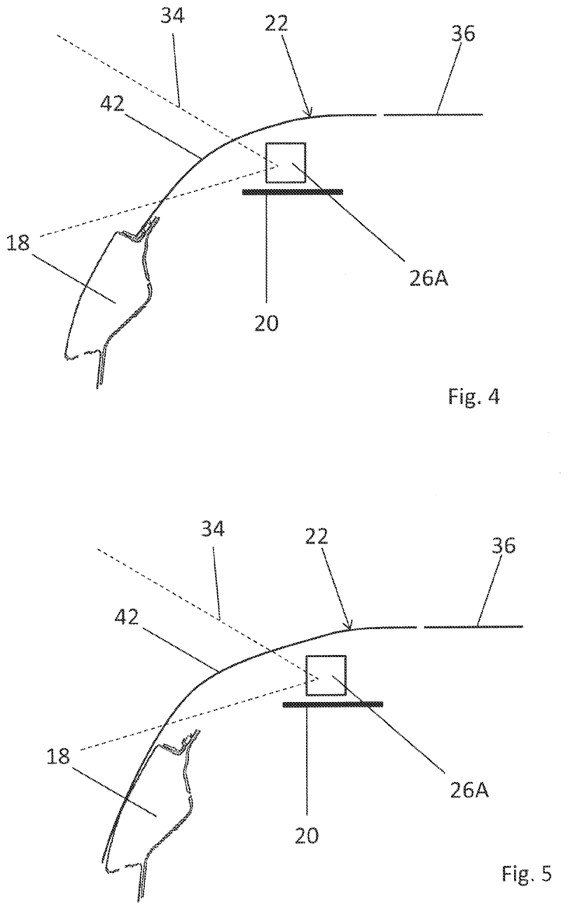

FIG. 4 shows a cross-sectional view of the roof module along cutting plane IV-IV in FIG. 1;

FIG. 5 shows a cross section according to FIG. 4 of an alternative embodiment; and

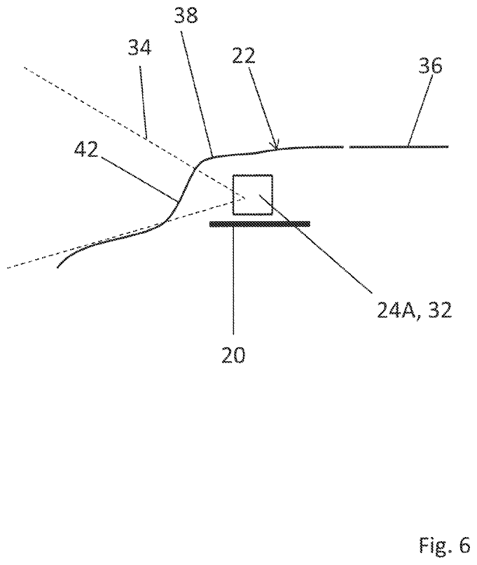

FIG. 6 shows a cross-sectional view of another embodiment of a vehicle roof.

FIG. 1 is a schematic top view of a vehicle roof 10 which is realized as a roof module and is placed on top a vehicle chassis as a unit; an A-pillar 12, a B-pillar 14 and a C-pillar 16 are illustrated in FIG. 1 on both sides of the vehicle chassis in relation to a vertical longitudinal roof center plane and are connected to each other via a corresponding longitudinal roof beam 18. Longitudinal roof beams 18 laterally limit the roof module or vehicle roof 10.

As is apparent in FIG. 4, for instance, roof module 10 comprises a roof substructure 20, which forms a roof frame and predetermines the rigidity of roof module 10, and a roof cladding 22, which forms an outer visible surface of roof module 10. With respect to the vertical longitudinal roof center plane, three sensor modules 24A, 26A, 28A and 24B, 26B, 28B are provided on each side, respectively, for the exemplary configuration at hand. Moreover, a sensor module 30 is provided in the front and the vehicle center and a sensor module 31 is provided in the rear and the vehicle center. Sensor modules 24A, 24B, 26A, 26B, 28A, 28B, 30 and 31 each comprise an environment sensor 32, by means of which the vehicle environment can be sensed for autonomously driving the vehicle in question. By evaluating the measuring signals of environment sensor 32 by means of a control unit, a corresponding traffic situation can thus be registered, whereby the vehicle in question can autonomously or partially autonomously make adjustments depending on traffic, Environment sensors 32 of sensor modules 24A, 24B, 26A, 26B, 28A, 28B, 30 and 31 can be realized in various manners and can comprise a Lidar sensor, a radar sensor, a camera (mono/multi/multifocal and/or stereo camera) and/or another suitable sensor. As illustrated in FIGS. 2, 3 and 4, environment sensors 32 each emit a signal cone 34, which has an opening angle adapted to the corresponding requirements.

Roof cladding 22 of roof module 10 has a central section 36, which is curved and thus reclines starting from a roof center and towards the rear and the front in the vehicle's longitudinal direction and in the vehicle's transverse direction following a curvature on both sides. In the vehicle longitudinal direction, a curved edge section 38 adjoins central section 36 in the front, edge section 38 forming a front windshield cowl adjacent to a windshield 40 and having an incline larger than that of central section 36. Three sensor modules 24A, 24B and 30 are disposed below edge section 38, which forms the front wind cowl, sensor modules 24A and 24B being disposed centrally in the corner areas of roof module 10 and sensor module 30 being disposed centrally with respect to the transverse extension of roof module 30. Accordingly, the three sensor modules 28A, 28B and 31 are allocated to a rear edge area 44, which forms a rear windshield cowl.

In the exemplary embodiment at hand, environment sensors 32 of sensor modules 24A, 24B and 30 each emit signal cone 34 toward the front during operation, signal cones 34 having an opening angle of approximately 17° from a horizontal plane downward, as can be seen in FIGS. 2 and 3. The front windshield cowl, which is formed by front edge section 38 of roof module 10, has an incline of 24.5° from the horizontal plane, meaning the downward opening angle of signal cone 34 is smaller than the incline of edge section 38. Consequently, environment sensors 32 each have an unimpeded view in each of the intended viewing directions, i.e., the view is not impeded by any other vehicle components, and can permeate the windshield 40.

The front windshield cowl, which is formed by edge section 38, is made of a plastic or glass visor which is transparent to the wavelengths with which environment sensors 32 work.

As described above, roof module 10 has a center sensor module 26A and 26B on each of its two sides with respect to the vertical longitudinal roof center plane, sensor modules 26A and 26B each having an environment sensor 32 which are also realized as Lidar sensors, for example, and are illustrated in FIG. 4. Sensor modules 26A and 26B are each placed below an edge section 42 of roof cladding 22, edge section 42 adjoining to central section 36 in the roof transverse direction and having an incline larger than that of central section 36 so that environment sensor 32 can sense the vehicle's environment in the lateral direction through edge section 42 made of a plastic visor. With their outer edges, lateral edge sections 42 each adjoin corresponding longitudinal roof beam 18 which is allocated to the vehicle chassis and lies outside of the viewing field of corresponding sensor module 26A and 26B.

In FIG. 5, a cross-sectional view of an alternative embodiment of a roof module is shown, which largely corresponds to that of FIGS. 1 to 4 but differs in that edge sections 42 of roof cladding 22 protrude beyond longitudinal roof beams 18, i.e., lie above longitudinal roof beams 18. In all other points, reference is made to the description of the embodiment according to FIGS. 1 to 4.

In the embodiment according to FIG. 6, sensor module 26A is disposed in such a manner that while signal cone 34 of environment sensor 32A lies above a roof line 46, which is formed by a front edge section 38, sensor module 26A partially lies below roof line 46 virtually continued toward the vehicle center.

### REFERENCE NUMERALS

10 motor vehicle
12 A-pillar
14 B-pillar
16 C-pillar
18 longitudinal roof beam
20 roof substructure
22 roof cladding
24A, B sensor module
26A, B sensor module
28A, B sensor module
30 sensor module
31 sensor module
32 environment sensor
34 signal cone
36 central section
38 edge section
40 windshield
42 edge section
44 edge section
46 roof line

1. A roof module of a motor vehicle, the roof module comprising:
a roof substructure,
a roof cladding, which forms an outer visible surface of the roof module, and
at least one sensor module having an environment sensor for sensing a vehicle environment,
the roof cladding having a central section having a curved surface and at least one edge section which adjoins the central section and whose incline is larger than that of the central section and which is transparent to the environment sensor at least in the area of a signal cone of the environment sensor,
the environment sensor being at least partially disposed below a roof surface defined by the roof cladding.

2. The roof module according to claim 1, wherein the edge section forms a front windshield cowl or a rear windshield cowl of the vehicle.

3. The roof module according to claim 1, wherein the edge section forms a lateral edge strip with respect to a vertical longitudinal roof center plane, the lateral edge strip adjoining a longitudinal roof beam of a vehicle chassis and/or extends thereover when a roof module is mounted.

4. The roof module according to claim 1, wherein the environment sensor emits a signal cone when in operation, which has an opening angle from a horizontal plane downward and is smaller than the incline of the lateral section.

5. The roof module according to claim 4, wherein the opening angle of the signal cone is 15° to 20° from a horizontal plane downward, and the incline of the edge section is larger by at least 4°.

6. The roof module according to claim 1, wherein the environment sensor is disposed centrally in a corner area of the roof module, in a lateral edge area of the roof module or in a front area or rear area of the roof module.

7. The roof module according to claim 1, wherein the edge section of the roof cladding is a visor, which comprises a window for the environment sensor.

8. A motor vehicle comprising a roof module according to claim 1.

9. The roof module according to claim 5, wherein the incline of the edge section is larger by at least 6°.
